(19) United States
(12) Patent Application Publication
(10) Pub. No.: US 2015/0372702 A1
(43) Pub. Date: Dec. 24, 2015

(54) FILTERS FOR A FREQUENCY BAND

(71) Applicant: QUALCOMM Incorporated, San Diego, CA (US)

(72) Inventors: Bhushan Shanti Asuri, San Diego, CA (US); Shrenik Patel, San Diego, CA (US); Chiewcharn Narathong, Saratoga, CA (US)

(21) Appl. No.: 14/476,536

(22) Filed: Sep. 3, 2014

Related U.S. Application Data
(60) Provisional application No. 62/016,609, filed on Jun. 24, 2014.

(51) Int. Cl. H04B 1/10; H04B 1/12; H04B 1/40

(52) U.S. Cl. CPC H04B 1/1027; H04B 1/40; H04B 1/12; H04B 2001/1072

(57) ABSTRACT

An apparatus includes a first filter tuned to a sub-band of a frequency band and a second filter tuned to the frequency band. The first filter is configured to be coupled to a receiver based on a first mode. The second filter is configured to be coupled to the receiver based on a second mode.

### I. CLAIM OF PRIORITY

The present application claims priority from U.S. Provisional Patent Application No. 62/016,609, entitled “FILTER CONFIGURATION FOR A FREQUENCY BAND,” filed Jun. 24, 2014, the contents of which is incorporated by reference in its entirety.

### II. FIELD

The present disclosure is generally related to filters for a frequency band.

### III. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

A wireless communications device may receive and transmit signals using a transceiver. In exemplary applications, the wireless communications device may receive and transmit signals over a Long-Term Evolution (LTE) B41 frequency band (e.g., the “B41” frequency band) using time division duplexing (TDD). To illustrate, the B41 frequency band may range between approximately 2496 megahertz (MHz) and 2690 MHz. The wireless communications device may transmit signals over the B41 frequency band at a first time, and the wireless communications device may receive signal over the B41 frequency band at a second time.

A wireless communication device may include three filters that are tuned to overlapping frequency bands within the B41 frequency band. For example, a wireless communication device may include a “B41-A” filter that is tuned to a frequency band between approximately 2496 MHz and 2566 MHz, a “B41-B” filter that is tuned to a frequency band between approximately 2525 MHz and 2620 MHz, and a “B41-C” filter that is tuned to a frequency band between approximately 2580 MHz and 2690 MHz.

Different service providers may support transmission and reception over different non-exclusive portions of the B41 frequency band. As a non-limiting example, a first service provider may support transmission and reception over substantially the entire B41 frequency band (e.g., approximately between 2496 MHz and 2690 MHz), and a second service provider may support transmission and reception over a sub-band of the B41 frequency band (e.g., approximately 2575 MHz and 2635 MHz). Because neither the B41-A filter, the B41-B filter, nor the B41-C filter is tuned to a frequency band that ranges between 2575 MHz and 2635 MHz, transmission and reception may be degraded by conventional wireless communication devices. For example, continuous downlink carrier aggregation for a frequency band ranging between 2575 MHz and 2635 MHz may not be supported for the service providers using conventional wireless communication devices.

### IV. BRIEF DESCRIPTION OF THE DRAWINGS

FIG. 1 shows a wireless device communicating with a wireless system;

FIG. 2 shows a block diagram of the wireless device in FIG. 1;

FIG. 3 shows additional components of the wireless device of FIGS. 1-2; and

FIG. 4 is a flowchart that illustrates an exemplary embodiment of a method for supporting continuous carrier aggregation for transmission and reception during multiple modes.

### V. DETAILED DESCRIPTION

The detailed description set forth below is intended as a description of exemplary designs of the present disclosure and is not intended to represent the only designs in which the present disclosure can be practiced. The term “exemplary” is used herein to mean “serving as an example, instance, or illustration.” Any design described herein as “exemplary” is not necessarily to be construed as preferred or advantageous over other designs. The detailed description includes specific details for the purpose of providing a thorough understanding of the exemplary designs of the present disclosure. It will be apparent to those skilled in the art that the exemplary designs described herein may be practiced without these specific details. In some instances, well-known structures and devices are shown in block diagram form in order to avoid obscuring the novelty of the exemplary designs presented herein.

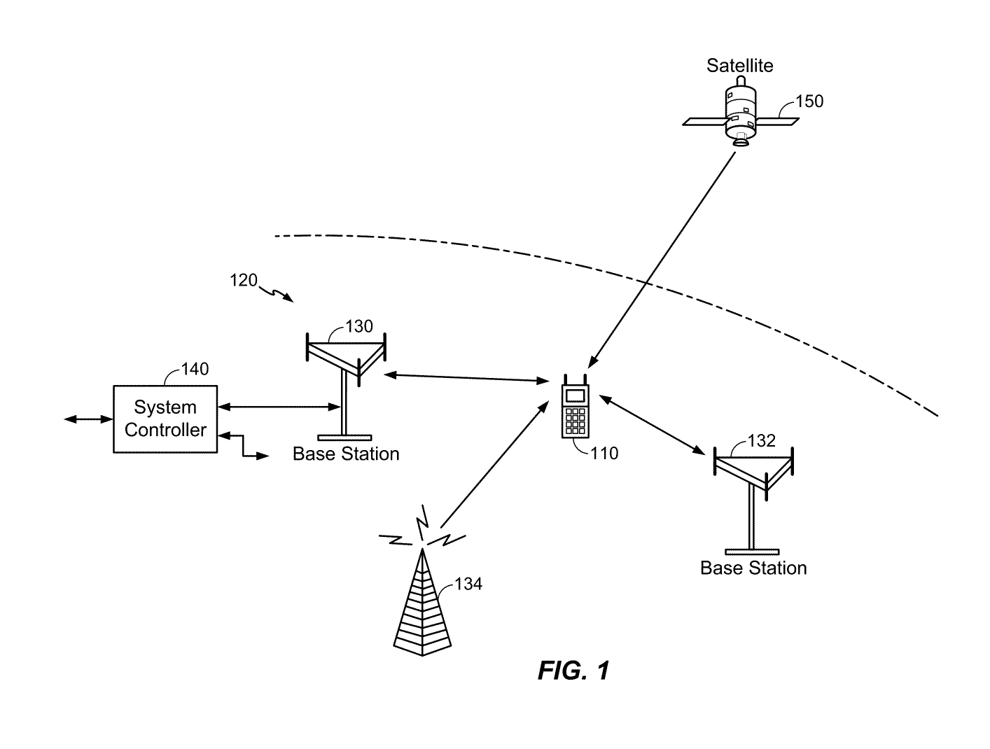

FIG. 1 shows a wireless device 110 communicating with a wireless communication system 120. Wireless communication system 120 may be a Long Term Evolution (LTE) system, a Code Division Multiple Access (CDMA) system, a Global System for Mobile Communications (GSM) system, a wireless local area network (WLAN) system, or some other wireless system. A CDMA system may implement Wideband CDMA (WCDMA), CDMA 1×, Evolution-Data Optimized (EVDO), Time Division Synchronous CDMA (TD-SCDMA), or some other version of CDMA. For simplicity, FIG. 1 shows wireless communication system 120 including two base stations 130 and 132 and one system controller 140. In general, a wireless system may include any number of base stations and any set of network entities.

Wireless device 110 may also be referred to as user equipment (UE), a mobile station, a terminal, an access terminal, a subscriber unit, a station, etc. Wireless device 110 may be a cellular phone, a smartphone, a tablet, a wireless modem, a personal digital assistant (PDA), a handheld device, a laptop computer, a smartbook, a netbook, a cordless phone, a wireless local loop (WLL) station, a Bluetooth device, etc. Wireless device 110 may communicate with wireless system 120. Wireless device 110 may also receive signals from broadcast stations (e.g., a broadcast station 134), signals from satellites (e.g., a satellite 150) in one or more global navigation satellite systems (GNSS), etc. Wireless device 110 may support one or more radio technologies for wireless communication such as LTE, WCDMA, CDMA 1×, EVDO, TD-SCDMA, GSM, 802.11, etc.

In an exemplary embodiment, the wireless device 110 of FIG. 1 may include a first filter tuned to a sub-band of a frequency band (e.g., tuned to a partial band of the frequency band). The first filter may be coupled to a receiver, a transmitter, and/or a transceiver in a first mode. In one example, a receiver and a transmitter may be included in a transceiver of the wireless device 110. It should be noted that although one or more embodiments may be illustrated and described herein with reference to a transceiver (that is capable of both transmitting and receiving data), such embodiments may also be applicable to a receiver that is incapable of transmitting data and a transmitter that is incapable of receiving data. For example, depending on implementation, the wireless device 110 may include separate receiver(s) and transmitter(s), transceiver(s) that include receiver(s) and transmitter(s), etc. Thus, a particular filter may be understood as being coupled to a receiver when the particular filter is coupled to a standalone receiver or when the particular filter is coupled to a transceiver that includes a receiver. Similarly, a particular filter may be understood as being coupled to a transmitter when the particular filter is coupled to a standalone transmitter or when the particular filter is coupled to a transceiver that includes a transmitter.

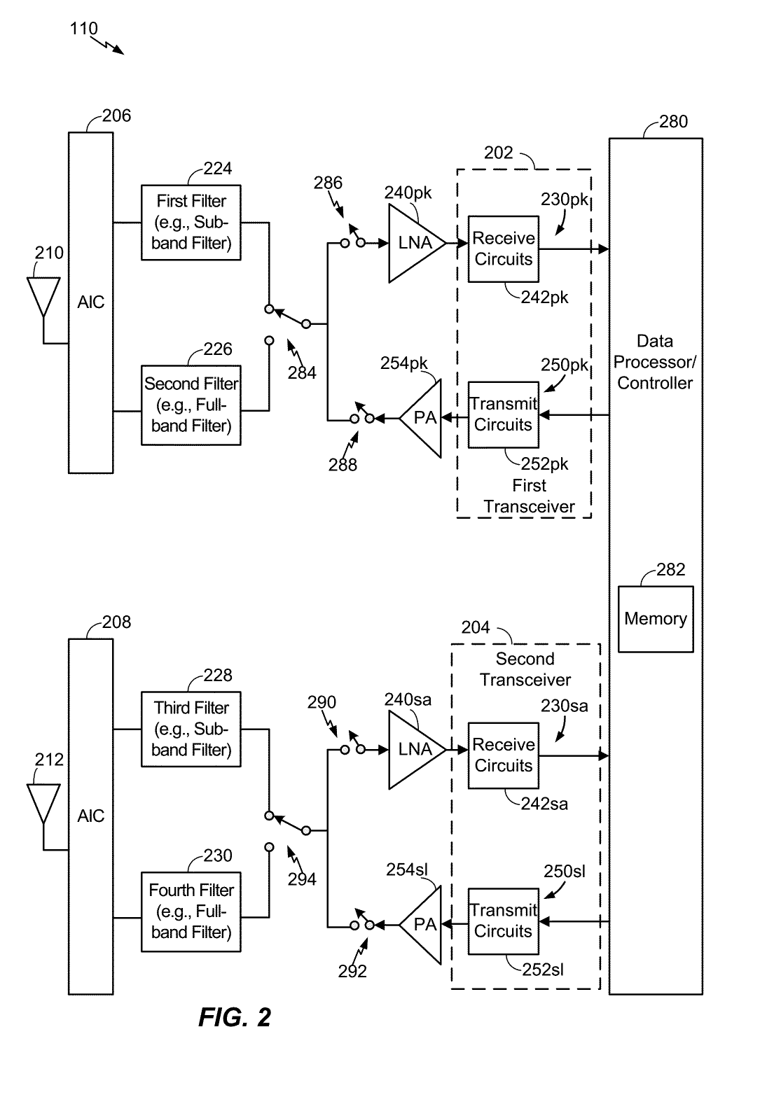

A mode of the wireless device 110 may correspond to a carrier service of the wireless device 110. For example, if the wireless device 110 uses a first carrier service to transmit and receive signals, the first filter may be coupled to the transceiver. Alternatively, the mode may correspond to a geographic location of the wireless device 110. For example, if the wireless device 110 is in a first geographic location, the first filter may be coupled to the transceiver. In an exemplary embodiment, the frequency band may be a Long-Term Evolution (LTE) frequency band (e.g., a LTE B41 frequency band). In other exemplary embodiments, the frequency band may be another LTE frequency band or a non-LTE frequency band. Thus, one or more embodiments described herein with reference to the LTE B41 frequency band may also be applicable to other frequency bands. As explained with respect to FIG. 2, the first filter may correspond to the first filter 224 of FIG. 2. The wireless device 110 may also include a second filter tuned to the frequency band (e.g., tuned to the entire frequency band). The second filter may be coupled to a receiver, a transmitter, and/or a transceiver in a second mode. For example, if the wireless device 110 uses a second carrier service to transmit and receive signals, the second filter may be coupled to the transceiver. Additionally, or in the alternative, if the wireless device 110 is in a second geographic location, the second filter may be coupled to the transceiver. As explained with respect to FIG. 2, the second filter may correspond to the second filter 226 of FIG. 2.

FIG. 2 shows a block diagram of an exemplary design of the wireless device 110 in FIG. 1. In this exemplary design, the wireless device 110 includes a first transceiver 202, a primary antenna 210, a second transceiver 204, a secondary antenna 212, and a data processor/controller 280. Although two transceivers 202, 204 are depicted in the embodiment of FIG. 2, in other exemplary embodiments, the wireless device 110 may include a single transceiver or the wireless device 110 may include more than two transceivers.

The first transceiver 202 includes a first receiver 230pk and a first transmitter 250pk. In other exemplary embodiments, the first transceiver 202 may include additional receivers, additional transmitters, or a combination thereof. In an alternative embodiment, the first receiver 230pk and the first transmitter 250pk may be separate components of the wireless device 110 instead of being part of a transceiver (e.g., the first transceiver 202). The first transceiver 202 may support multiple frequency bands, including the “B41” frequency band. For example, the first transceiver 202 may support signal transmission and signal reception in a frequency band ranging from approximately 2496 megahertz (MHz) and 2690 MHz. The first transceiver 202 may also support multiple radio technologies, continuous carrier aggregation, receive diversity, multiple-input multiple-output (MIMO) transmission from multiple transmit antennas to multiple receive antennas, etc. As a non-limiting example and as further described below with respect to the filters 224, 226, the transceiver first 202 may support continuous carrier aggregation for a frequency band ranging between 2575 MHz and 2635 MHz that may not be supported using conventional wireless communication devices (e.g., wireless devices using a B41-A filter, a B41-B filter, and a B41-C filter). For example, based on the mode of the wireless device 110 (e.g., based on the location and/or the carrier service of the wireless device 110), the first transceiver 202 may be coupled to the first filter 224 or to the second filter 226 to support continuous carrier aggregation for the mode.

In a particular embodiment, the mode may be “fixed” such that the first transceiver 202 is coupled to the first filter 224 or to the second filter 226 prior to a product release associated with the wireless device 110. As a non-limiting example, upon a determination that a product release of the wireless device 110 is for a first geographic location (e.g., China), the first transceiver 202 may be coupled to the first filter 224. Alternatively, upon a determination that the product release is for a second geographic location (e.g., North America), the first transceiver 202 may be coupled to the second filter 226.

As another non-limiting example of a “fixed mode”, upon a determination that the produce release is for a first carrier service (e.g., a carrier service that operates over a sub-band of the B41 frequency band), the first transceiver 202 may be coupled to the first filter 224. Alternatively, upon a determination that the product release is for a second carrier service (e.g., a carrier service that operates over substantially the entire B41 frequency band), the first transceiver 202 may be coupled to the second filter 226. Including the first filter 224 and the second filter 226 in the wireless device 110 may simplify the design process of the wireless device 110 such that versions of the wireless device 110 in different geographic locations and/or for different service providers have a substantially similar architecture.

In another particular embodiment, the mode may be “dynamic” such that the data processor/controller 280 may selectively couple the first transceiver 202 to the first filter 224 or to the second filter 226. For example, the data processor/controller 280 may determine global positioning system (GPS) coordinates associated with a location of the wireless device 110. Based on the GPS coordinates, the data processor/controller 280 may determine whether the wireless device 110 is in the first geographic location corresponding to the first mode or the second geographic location corresponding to the second mode. As another example, the data processor/controller 280 may determine whether the wireless device 110 is connected to the first carrier service corresponding to the first mode or to the second carrier service corresponding to the second mode based on provisioning information of the wireless device 110, information stored in a subscriber identity module (SIM) of the wireless device 110, etc. As described below, the data processor/controller 280 may control the switches 284, 286, 288 to selectively couple to the first transceiver 202 to the first filter 224 or to the second filter 226 based on the mode.

The first receiver 230pk may include a low noise amplifier (LNA) 240pk coupled to receive circuitry 242pk. In an exemplary embodiment, the LNA 240pk may be within the receive circuitry 242pk. The LNA 240pk may be configured to amplify an input radio frequency (RF) signal and to provide an output RF signal. The receive circuitry 242pk may be configured to downconvert the output RF signal from RF to baseband, to amplify and filter the downconverted signal, and to provide an analog input signal to the data processor/controller 280. The receive circuitry 242pk may include mixers, filters, amplifiers, matching circuits, an oscillator, a local oscillator (LO) generator, a phase locked loop (PLL), etc.

The first transmitter 250pk may also include a power amplifier (PA) 254pk coupled to transmit circuitry 252pk. In an exemplary embodiment, the power amplifier 254pk may be within the transmit circuitry 252pk. For data transmission, the data processor/controller 280 may be configured to process (e.g., encode and modulate) data to be transmitted and to provide an analog output signal to the transmit circuitry 252pk. The transmit circuitry 252pk may be configured to amplify, filter, and upconvert the analog output signal from baseband to RF and to provide a modulated RF signal. The transmit circuitry 252pk may include amplifiers, filters, mixers, matching circuits, an oscillator, an LO generator, a PLL, etc. The power amplifier 254pk may be configured to receive and amplify the modulated RF signal and to provide a transmit RF signal having a selected output power level.

The second transceiver 204 includes a second receiver 230sa and a second transmitter 250s1. In other exemplary embodiments, the second transceiver 204 may include additional receivers, additional transmitters, or a combination thereof. In an alternative embodiment, the second receiver 230sa and the second transmitter 250s1 may be separate components of the wireless device 110 instead of being part of a transceiver (e.g., the second transceiver 204). The second receiver 204 may support multiple frequency bands, including the B41 frequency band. For example, the second transceiver 204 may support signal transmission and signal reception within the frequency band ranging from approximately 2496 megahertz (MHz) and 2690 MHz. The second transceiver 204 may also support multiple radio technologies, carrier aggregation, receive diversity, MIMO transmission from multiple transmit antennas to multiple receive antennas, etc.

The second receiver 230sa may include LNA 240sa coupled to receive circuitry 242sa. In an exemplary embodiment, the LNA 240sa may be within the receive circuitry 242sa. The LNA 240sa may be configured to amplify an input RF signal and to provide an output RF signal. The receive circuitry 242sa may be configured to downconvert the output RF signal from RF to baseband, to amplify and filter the downconverted signal, and to provide an analog input signal to the data processor/controller 280. The receive circuitry 242sa may include mixers, filters, amplifiers, matching circuits, an oscillator, an LO generator, a PLL, etc.

The second transmitter 250s1 may also include a power amplifier (PA) 254s1 coupled to transmit circuitry 252s1. In an exemplary embodiment, the power amplifier 254s1 may be within the transmit circuitry 252s1. For data transmission, the data processor/controller 280 may be configured to process (e.g., encode and modulate) data to be transmitted and to provide an analog output signal to the transmit circuitry 252s1. The transmit circuitry 252s1 may be configured to amplify, filter, and upconvert the analog output signal from baseband to RF and to provide a modulated RF signal. The transmit circuitry 252s1 may include amplifiers, filters, mixers, matching circuits, an oscillator, an LO generator, a PLL, etc. The power amplifier 254s1 may be configured to receive and amplify the modulated RF signal. The amplified modulated signal may be filtered via a filter 228, 230 and transmitted as a RF signal via the secondary antenna 212.

The wireless device 110 includes a first filter 224, a second filter 226, a third filter 228, and a fourth filter 230. Although four filters 224, 226, 228, 230 are illustrated in the wireless device 110 of FIG. 2, in other exemplary embodiments, the wireless device 110 may only include the first filter 224 and the second filter 226 (e.g., the wireless device 110 may not include the second transceiver 204 and the corresponding filters 228, 230).

The first filter 224 (e.g., a sub-band filter) may be tuned to a sub-band of the B41 frequency band. As a non-limiting example, the first filter 224 may be tuned to a frequency band between approximately 2525 MHz and 2690 MHz. In this exemplary embodiment, the first filter 224 may be tuned to “cover” frequencies covered by a B41-B filter and a B41-C filter in a conventional wireless device. The second filter 226 (e.g., a full-band filter) may be tuned to approximately the entire B41 frequency band. As a non-limiting example, the second filter 226 may be tuned to a frequency band between approximately 2496 MHz and 2690 MHz. In this exemplary embodiment, the second filter 226 may be tuned to cover frequencies covered by a B41-A filter, the B41-B filter, and the B41-C filter in the conventional wireless device.

The third filter 228 (e.g., a sub-band filter) may be tuned to a sub-band of the B41 frequency band. As a non-limiting example, the third filter 228 may be tuned to a frequency band between approximately 2525 MHz and 2690 MHz. The fourth filter 230 (e.g., a full-band filter) may be tuned to approximately the entire B41 frequency band. As a non-limiting example, the fourth filter 230 may be tuned to a frequency band between approximately 2496 MHz and 2690 MHz.

Although the first filter 224 and the third filter 228 are described to cover substantially the same frequency bands, in other exemplary embodiments, the first filter 224 and the third filter 228 may cover different frequency bands. As a non-limiting example, the third filter 228 may be tuned to a frequency band between approximately 2496 MHz and 2620 MHz. In this exemplary embodiment, the third filter 228 may be tuned to cover frequencies covered by the B41-A filter and the B41-B filter in the conventional wireless device.

The LNA 240pk of the first transceiver 202 may be selectively coupled to the first filter 224 or to the second filter 226 via a switch 286 and a switch 284. For example, during a reception operation, the data processor/controller 280 may selectively activate (e.g., close) the switch 286 so that incoming signals may be provided to the LNA 240pk.

If a service provider associated with the wireless device 110 supports signal reception over a sub-band of the B41 frequency band (e.g., supports signal reception over a frequency band ranging approximately between 2525 MHz and 2690 MHz), the data processor/controller 280 may couple the switch 284 to the first filter 224. When the switch 284 is coupled to the first filter 224, incoming RF signals received by the primary antenna 210 are routed through an antenna interface circuit (AIC) 206 and provided to the first filter 224. The first filter 224 may filter the incoming RF signal and provide the filtered signal (via the switch 284 and the switch 286) to the receiver 230pk for processing, as described above.

If the service provider associated with the wireless device 110 supports signal reception over the entire B41 frequency band (e.g., supports signal reception over a frequency band ranging approximately between 2496 MHz and 2690 MHz), the data processor/controller 280 may couple the switch 284 to the second filter 226. When the switch 284 is coupled to the second filter 226, incoming RF signals received by the primary antenna 210 are routed through the AIC 206 and provided to the second filter 226. The second filter 226 may filter the incoming RF signal and may provide the filtered signal (via the switch 284 and the switch 286) to the receiver 230pk for processing, as described above.

The power amplifier 254pk of the first transceiver 202 may be selectively coupled to the first filter 224 or to the second filter 226 via a switch 288 and the switch 284. For example, during a transmission operation, the data processor/controller 280 may selectively activate (e.g., close) the switch 288 such that transmission signals are provided to one of the filters 224, 226 via the transmission path.

If the service provider associated with the wireless device 110 supports signal transmission over the sub-band of the B41 frequency band, the data processor/controller 280 may couple the switch 284 to the first filter 224. When the switch 284 is coupled to the first filter 224, transmission signals are filtered by the first filter 224, routed through the AIC 206, and transmitted over a wireless network via the primary antenna 210.

If the service provider associated with the wireless device 110 supports signal transmission over the entire B41 frequency band, the data processor/controller 280 may couple the switch 284 to the second filter 226. When the switch 284 is coupled to the second filter 226, transmission signals are filtered by the second filter 226, routed through the AIC 206, and transmitted over the wireless network via the primary antenna 210.

In a similar manner as described with respect to the LNA 240pk of the first transceiver 202, the LNA 240sa of the second transceiver 204 may be selectively coupled to the third filter 228 or to the fourth filter 230 via a switch 290 and a switch 294. For example, during a reception operation, the data processor/controller 280 may selectively activate (e.g., close) the switch 290 such that incoming signals may be provided to the LNA 240sa.

If a service provider associated with the wireless device 110 supports signal reception over a sub-band of the B41 frequency band covered by the third filter 228, the data processor/controller 280 may couple the switch 294 to the third filter 228. When the switch 294 is coupled to the third filter 228, incoming RF signals received by the secondary antenna 212 are routed through an AIC 208 and provided to the third filter 228. The third filter 228 may filter the incoming RF signal and provide the filtered signal to the receiver 230sa for processing, as described above.

If the service provider associated with the wireless device 110 supports signal reception over the entire B41 frequency band (e.g., supports signal reception over a frequency band ranging approximately between 2496 MHz and 2690 MHz), the data processor/controller 280 may couple the switch 294 to the fourth filter 230. When the switch 294 is coupled to the fourth filter 230, incoming RF signals received by the secondary antenna 212 are routed through the AIC 208 and provided to the fourth filter 230. The fourth filter 230 may filter the incoming RF signal and provide the filtered signal to the receiver 230sa for processing, as described above.

In a similar manner as described with respect to the power amplifier 254pk of the first transceiver 202, the power amplifier 254s1 of the second transceiver 204 may be selectively coupled to the third filter 228 or to the fourth filter 230 via a switch 292 and the switch 294. For example, during a transmission operation, the data processor/controller 280 may selectively activate (e.g., close) the switch 292 such that transmission signals are provided to one of the filters 228, 230 via the transmission path.

If the service provider associated with the wireless device 110 supports signal transmission over the sub-band of the B41 frequency band, the data processor/controller 280 may couple the switch 294 to the third filter 228. When the switch 294 is coupled to the third filter 228, transmission signals are filtered by the third filter 228, routed through the AIC 208, and transmitted over the wireless network via the secondary antenna 212.

If the service provider associated with the wireless device 110 supports signal transmission over the entire B41 frequency band, the data processor/controller 280 may couple the switch 294 to the fourth filter 230. When the switch 294 is coupled to the fourth filter 230, transmission signals are filtered by the fourth filter 230, routed through the AIC 208, and transmitted over the wireless network via the secondary antenna 212.

FIG. 2 shows an exemplary design of receivers 230pk, 230sa and an exemplary design of transmitters 250pk, 250s1. A receiver and a transmitter (e.g., a transceiver) may also include other circuits not shown in FIG. 2, such as filters, matching circuits, etc. All or a portion of transceivers may be implemented on one or more analog integrated circuits (ICs), RF ICs (RFICs), mixed-signal ICs, etc.

The data processor/controller 280 may perform other functions for the wireless device 110. For example, the data processor/controller 280 may perform processing for data being received via the receivers 230pk, 230sa and data being transmitted via the transmitters 250pk, 250s1. The data processor/controller 280 may control the operation of the various circuits within transceivers 202, 204. A memory 282 may store programmable code and data for the data processor/controller 280. The data processor/controller 280 may be implemented by one or more application specific integrated circuits (ASICs) and/or other ICs.

The wireless device 110 may support multiple band groups, multiple radio technologies, and/or multiple antennas. The wireless device 110 may include a number of LNAs to support reception via the multiple frequency band groups, multiple radio technologies, and/or multiple antennas.

It will be appreciated that the wireless device 110 may support signal reception and transmission for service providers that transmit/receive signals over the entire B41 frequency band (e.g., approximately between 2496 MHz and 2690 MHz) and service providers that transmit/receive signals over a sub-band of the B41 frequency band (e.g., approximately between 2525 MHz and 2690 MHz). For example, using the first filter 224, the wireless device 110 may support continuous downlink carrier aggregation for a frequency band ranging between 2575 MHz and 2635 MHz. Thus, service providers (e.g., carrier services) that receive signals over the sub-band of the B41 frequency band (e.g., the sub-band ranging from approximately 2575 MHz-2635 MHz) may benefit from continuous downlink carrier aggregation capabilities as compared to conventional wireless devices having a B41-A filter, a B41-B filter, and a B41-C filter. As a non-limiting example, the first filter 224 may be used (e.g., coupled to the first transceiver 202) if the first carrier service is associated with the wireless device 110 and/or if the wireless device 110 is in a first geographic location (e.g., China). This scenario may correspond to the wireless device 110 operating in a “first mode.” Additionally, using the second filter 226, the wireless device 110 may support continuous downlink carrier aggregation for service providers that receive signals over the entire B41 frequency band. As a non-limiting example, the second filter 226 may be used (e.g., coupled to the first transceiver 202) if the second carrier service is associated with the wireless device 110 and/or if the wireless device 110 is in a second geographic location (e.g., North America). This scenario may correspond to the wireless device 110 operating in a “second mode.”

To illustrate, the data processor/controller 280 may couple the switches 284, 294 to the second filter 226 and to the fourth filter 230, respectively, for a service provider in North America that transmits/receives signals over the entire B41 frequency band. Additionally, the data processor/controller 280 may couple the switches 284, 294 to the first filter 224 and to the third filter 228, respectively, for a service provider in China that transmits/receives signals over a sub-band of the B41 frequency band. For example, the service provider in China may transmit/receive signals over a frequency range spanning between approximately 2575 MHz and 2635 MHz. Coupling the switches 284, 294 to the first filter 224 and to the third filter 228, respectively, may enable the wireless device 110 to support continuous time division duplexing (TDD) downlink carrier aggregation for the service provider in China (as opposed to a conventional wireless communication device that would support continuous TDD downlink carrier aggregation for the portion of the frequency range associated with a B41-B filter or the portion of the frequency range associated with a B41-C filter). For example, the frequency range of the filters 224, 228 may span from approximately 2525 MHz to 2690 MHz, which “covers” the service provider in China transmitting/receiving signals over the frequency range spanning between approximately 2575 MHz and 2635 MHz. However, the conventional B41-B filter spans from approximately 2525 MHz to 2620 MHz, which excludes portions of the frequency range associated with the service provider in China. Additionally, the conventional B41-C filter spans from approximately 2580 MHz to 2690 MHz, which excludes portions of the frequency range associated with the service provider in China.

It will also be appreciated that the wireless device 110 may improve WLAN signal rejection. As a non-limiting example, the service provider in China may have a WLAN frequency range spanning between approximately 2473 MHz to 2495 MHz. If the switches 284, 294 are coupled to the first filter 224 and the third filter 228, respectively, to cover a frequency band between approximately 2525 MHz and 2690 MHz, the filters 224, 228 may reject (e.g., block) WLAN signals (or reduce the WLAN signals) to reduce interference. Using two filters 224, 228 may also occupy less die area than three filters (e.g., the B41-A filter, the B41-B filter, and the B41-C filter used in conventional wireless devices).p

Although FIG. 2 illustrates three switches 284, 286, and 288 to selectively couple and decouple the LNA 240pk and/or the power amplifier 254pk to the first filter 224 of the second filter 226, in other implementations one or more other mechanisms may be configured to enable coupling and decoupling of the LNA 240pk and/or the power amplifier 254pk to the first filter 224 of the second filter 226. For example, other configurations of switching circuitry may be used in place of the three switches 284-288. To illustrate, in another implementation, a pair of single-pole double-throw switches may be used to enable selective coupling and decoupling of the LNA 240pk and/or the power amplifier 254pk to the first filter 224 of the second filter 226. Similarly, in other implementations, other switching mechanisms may be used in place of the switches 290-294.

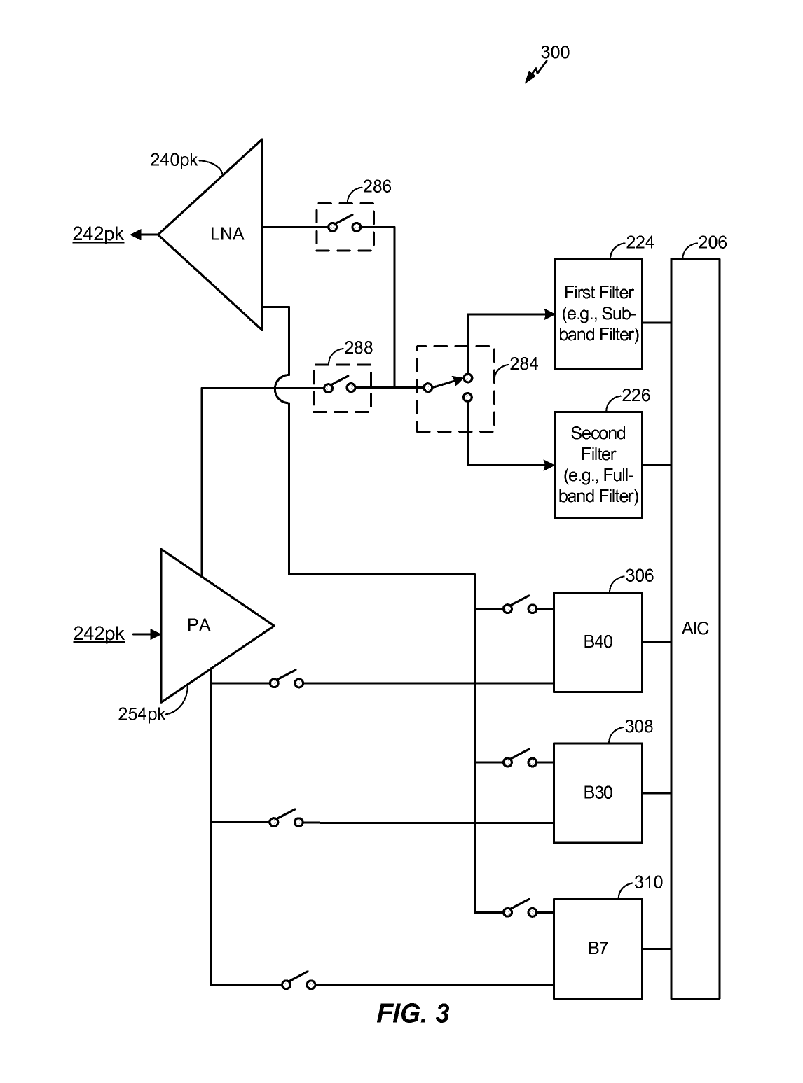

Referring to FIG. 3, an exemplary embodiment of a system 300 that includes additional components of the wireless device 110 of FIGS. 1-2 is shown. To illustrate, one or more components of the system 300 may be included within or be coupled to a transmitter, a receiver, and/or a transceiver. As shown in FIG. 3, the system 300 may include the LNA 240pk, the power amplifier 254pk, the first filter 224, the second filter 226, the switch 286, the switch 288, and the switch 284.

The system 300 may also include a filter 306, a filter 308, and a filter 310. The filter 306 may support time division duplexing (TDD) and may be selectively coupled to the LNA 240pk and to the power amplifier 254pk by switches. The filters 308, 310 may support frequency division duplexing (FDD) and may be selectively coupled to the LNA 240pk and to the power amplifier 254pk by switches. In an exemplary embodiment, the filter 306 may be tuned to an LTE B40 frequency band. For example, the filter 306 may be tuned between approximately 2300 MHz and 2400 MHz. In an exemplary embodiment, the filter 308 may be tuned to an LTE B30 frequency band, and the filter 310 may be tuned to an LTE B7 frequency band.

The system 300 of FIG. 3 may support signal reception and transmission for service providers that transmit and/or receive signals over the entire B41 frequency band (e.g., approximately between 2496 MHz and 2690 MHz) and service providers that transmit and/or receive signals over a sub-band of the B41 frequency band (e.g., approximately between 2525 MHz and 2690 MHz). For example, the system 300 may support continuous downlink carrier aggregation for service providers that receive signals over the sub-band (e.g., approximately 2575 MHz and 2635 MHz) of the B41 frequency band or for service providers that receive signals over the entire B41 frequency band. For example, the switch 284 may couple to the first filter 224 to support continuous downlink carrier aggregation over the sub-band of the B41 frequency band, and the switch may couple to the second filter 226 to support continuous downlink carrier aggregation over the entire B41 frequency band.

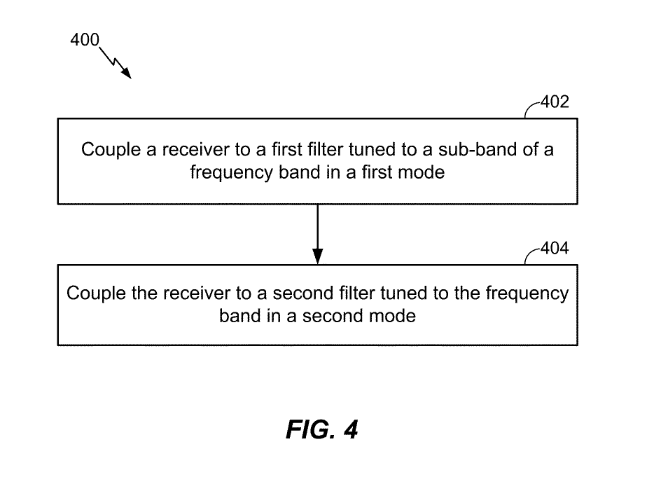

Referring to FIG. 4, a flowchart that illustrates an exemplary embodiment of a method 400 for supporting continuous carrier aggregation for transmission and reception during multiple modes is shown. In an illustrative embodiment, the method 400 may be performed using components of the wireless device 110 of FIGS. 1-2, the system 300 of FIG. 3, or any combination thereof.

The method 400 includes in a first mode, coupling a receiver to a first filter tuned to a sub-band of a frequency band, at 402. Alternatively, or in addition, a transmitter or a transceiver may be coupled to the first filter in the first mode. For example, referring to FIG. 2, the data processor/controller 280 may couple the first filter 224 to the first transceiver 202 (which includes the first receiver 230pk and the first transmitter 250pk) via the switches 286, 288, 284. The first filter 224 may be tuned to a sub-band of a B41 frequency band. For example, the first filter 224 may be tuned to a frequency band that spans between approximately 2525 MHz and 2690 MHz. In another embodiment, the first filter 224 may be coupled to the first transceiver 202 prior to a product release of the wireless device 110. For example, prior to product release, the mode may be “fixed” such that first filter 224 is coupled to the first transceiver 202. The mode may be based on a geographic location of the wireless device 110 and/or a carrier service associated with the wireless device 110.

In a second mode, the receiver may be coupled to a second filter tuned to the frequency band, at 404. Alternatively, or in addition, a transmitter or a transceiver may be coupled to the second filter in the second mode. For example, referring to FIG. 2, the data processor/controller 280 may couple the second filter 226 to the first transceiver 202 (which includes the first receiver 230pk and the first transmitter 250pk) via the switches 286, 288, 284. The second filter 226 may be tuned to the B41 frequency band. For example, the second filter 226 may be tuned to a frequency band that spans between approximately 2496 MHz and 2690 MHz. In another embodiment, the second filter 226 may be coupled to the first transceiver 202 prior to the product release of the wireless device 110. For example, prior to product release, the mode may be “fixed” such that second filter 226 is coupled to the first transceiver 202.

The method 400 of FIG. 4 may support signal reception and transmission for service providers that transmit and/or receive signals over the entire frequency band (e.g., approximately between 2496 MHz and 2690 MHz in the case of LTE B41) and service providers that transmit and/or receive signals over a sub-band of the B41 frequency band (e.g., approximately between 2525 MHz and 2690 MHz). For example, the wireless device 110 may support continuous downlink carrier aggregation for service providers that receive signals over the sub-band of the B41 frequency band or for service providers that receive signals over the entire B41 frequency band. For example, the frequency range of the first filter 224 may span from approximately 2525 MHz to 2690 MHz, which “covers” the service provider in China transmitting/receiving signals over the frequency range spanning between approximately 2575 MHz and 2635 MHz. However, the conventional B41-B filter spans from approximately 2525 MHz to 2620 MHz, which excludes portions of the frequency range associated with the service provider in China. Additionally, the conventional B41-C filter spans from approximately 2580 MHz to 2690 MHz, which excludes portions of the frequency range associated with the service provider in China. The frequency range of the second filter 226 may span from approximately 2496 MHz to 2690 MHz, which “covers” the service provider in North America.

In conjunction with the described embodiments, an apparatus includes a first means for filtering tuned to a sub-band of a B41 frequency band. The first means for filtering may be selectively coupled to means for receiving signals. For example, the first means for filtering may include or correspond to the first filter 224 of FIGS. 2-3, the third filter 228 of FIG. 2, one or more other devices, circuits, modules, or any combination thereof. The means for receiving signals may include or correspond to the first transceiver 202 of FIG. 2, the first receiver 230pk of FIG. 2, the second transceiver 204 of FIG. 2, the second receiver 230sa of FIG. 2, the LNA 240pk of FIGS. 2-3, the LNA 240sa of FIG. 2, one or more other devices, circuits, modules, or any combination thereof.

The apparatus may also include second means for filtering tuned to the B41 frequency band. The second means for filtering may be selectively coupled to the means for receiving signals. For example, the second means for filtering may include or correspond to the second filter 226 of FIGS. 2-3, the fourth filter 230 of FIG. 2, one or more other devices, circuits, modules, or any combination thereof. In a particular embodiment, the first means for filtering and the second means for filtering may selectively be coupled to means for transmitting signals. The means for transmitting signals may include or correspond to the first transceiver 202 of FIG. 2, the first transmitter 250pk of FIG. 2, the second transceiver 204 of FIG. 2, the second transmitter 250s1 of FIG. 2, the PA 254pk of FIGS. 2-3, the PA 254s1 of FIG. 2, one or more other devices, circuits, modules, or any combination thereof. Alternatively, the means for transmitting signals and the means for receiving signals may be included in a means for transmitting and receiving signals, which may include or correspond to the first transceiver 202 of FIG. 2, the first receiver 230pk of FIG. 2, the first transmitter 250pk of FIG. 2, the second transceiver 204 of FIG. 2, the second receiver 230sa of FIG. 2, the second transmitter 250s1 of FIG. 2, the LNA 240pk of FIGS. 2-3, the LNA 240sa of FIG. 2, the PA 254pk of FIGS. 2-3, the PA 254s1 of FIG. 2, one or more other devices, circuits, modules, or any combination thereof.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. An apparatus comprising:
a first filter tuned to a sub-band of a frequency band, the first filter configured to be coupled to a receiver based on a first mode; and
a second filter tuned to the frequency band, the second filter configured to be coupled to the receiver based on a second mode.

2. The apparatus of claim 1, wherein the first mode is associated with a first carrier service, and wherein the second mode is associated with a second carrier service.

3. The apparatus of claim 1, wherein the first mode is associated with a first geographic location, and wherein the second mode is associated with a second geographic location.

4. The apparatus of claim 1, wherein the receiver is included in a transceiver.

5. The apparatus of claim 1, wherein, in the first mode, the first filter is coupled to a transmitter, and wherein, in the second mode, the second filter is coupled to the transmitter.

6. The apparatus of claim 5, wherein the receiver and the transmitter are included in a transceiver.

7. The apparatus of claim 1, wherein the frequency band is a Long-Term Evolution (LTE) frequency band.

8. The apparatus of claim 7, wherein the LTE frequency band is a B41 frequency band.

9. The apparatus of claim 8, wherein the B41 frequency band spans frequencies between approximately 2496 megahertz (MHz) and 2690 MHz.

10. The apparatus of claim 8, wherein the sub-band spans frequencies between approximately 2525 megahertz (MHz) and 2690 MHz.

11. The apparatus of claim 1, further comprising a first switch configured to:
selectively couple the first filter to the receiver; and
selectively couple the second filter to the receiver.

12. The apparatus of claim 11, further comprising a second switch coupled to the first switch, wherein the second switch is configured to selectively couple the first filter or the second filter to a low noise amplifier.

13. The apparatus of claim 11, further comprising a third switch coupled to the first switch, wherein the third switch is configured to selectively couple the first filter or the second filter to a power amplifier.

14. An apparatus comprising:
first means for filtering tuned to a sub-band of a frequency band, the first means for filtering configured to be coupled to means for receiving signals based on a first mode; and
second means for filtering tuned to the frequency band, the second means for filtering configured to be coupled to the means for receiving signals based on a second mode.

15. The apparatus of claim 14, wherein the first mode is associated with a first carrier service, and wherein the second mode is associated with a second carrier service.

16. The apparatus of claim 14, wherein the first mode is associated with a first geographic location, and wherein the second mode is associated with a second geographic location.

17. The apparatus of claim 14, further comprising first means for switching configured to:
selectively couple the first means for filtering to the means for receiving signals; and
selectively couple the second means for filtering to the means for receiving signals.

18. A method comprising:
coupling a receiver to a first filter tuned to a sub-band of a frequency band based on a first mode; and
coupling the receiver to a second filter tuned to the frequency band based on a second mode.

19. The method of claim 18, wherein the first mode is associated with a first carrier service, and wherein the second mode is associated with a second carrier service

20. The method of claim 18, wherein the frequency band is a Long-Term Evolution (LTE) B41 frequency band.
